(19) United States
(12) Patent Application Publication
(10) Pub. No.: US 2014/0104860 A1
(43) Pub. Date: Apr. 17, 2014

(54) LIGHTING DEVICE FOR A CAR LAMP

(71) Applicant: DBM REFLEX OF TAIWAN CO., LTD., Tainan (TW)

(72) Inventor: Min-Hwa CHOU, Tainan (TW)

(73) Assignee: DBM REFLEX OF TAIWAN CO., LTD., Tainan (TW)

(21) Appl. No.: 13/650,856

(22) Filed: Oct. 12, 2012

(51) Int. Cl. F21S 8/10

(52) U.S. Cl. CPC F21S 48/00
USPC 362/487

(57) ABSTRACT

A lighting device for a car lamp has a base, at least one controlling board and at least one LED module. The at least one controlling board is mounted on an assembling surface of the base and extends outside the base to reduce the volume of the base. Each one of the at least one controlling board has an outer side surface and a working surface formed on the outer side surface and parallel to the axis of the base. The at least one LED module is mounted respectively on the working surface of the at least one controlling board to increase the illumination of the side area of the lighting device. Thus, the light-homogenizing effect for the light emitted from the lighting device is improved.

### BACKGROUND OF THE INVENTION

1. Field of the Invention

The present invention relates to a lighting device, and more particularly to a lighting device for a car lamp to provide a light-homogenizing effect.

2. Description of Related Art

An LED (light emitting diode) is a point light source and has characteristics of small volume, high luminance, low energy-consumption and long service life. Therefore, LED has been widely used in car lamps and the like. A car lamp has a seat, a lighting device and a lampshade. A chamber is defined in the seat. An opening is formed in the seat and in communication with the chamber. The lighting device is mounted on the seat. The lampshade is mounted on the seat and closes the opening of the seat. The lighting device has a base, a controlling board and an LED. The base has a working surface facing the opening of the seat. The controlling board is mounted on the base. The LED is mounted on the working surface of the base and is electrically connected to the controlling board and has a light-emitting end facing the opening of the seat.

The LED of the lighting device is a point light source, so a light emitting angle of the LED is narrow, and the lighting device provides the working surface facing the opening of the seat. Therefore, the light emitted from the LED of the lighting device mostly illuminates a front area of the car lamp. Although the illumination of the front area of the car lamp is sufficient, the illumination of the side area of the car lamp is insufficient. Thus, the light-homogenizing effect of the conventional lighting device is poor. Moreover, the base must provide enough assembling space to install the controlling board, so the volume of the base cannot be reduced effectively.

To overcome the shortcomings, the present invention tends to provide a lighting device to mitigate or obviate the aforementioned problems.

### SUMMARY OF THE INVENTION

The main objective of the invention is to provide a lighting device for a car lamp to improve the light-homogenizing effect for the light emitted from the lighting device and reduce the volume of the base.

The lighting device for a car lamp has a base, at least one controlling board and at least one LED module. The base has an axis and an assembling surface. The axis is defined axially through the base. The assembling surface is defined radially on the base. The at least one controlling board is mounted on the assembling surface of the base and extends outside the base around the axis of the base. Each one of the at least one controlling board has an outer side surface and a working surface formed on the outer side surface. The at least one LED module is mounted respectively on the working surface of the at least one controlling board and each one of the at least one LED module has at least one LED.

The at least one controlling board is mounted on the assembling surface of the base and extends outside the base, so the base does not have to provide an extra assembling space to install the at least one controlling board, and therefore the volume of the base is reduced. Furthermore, the at least one LED module mounted on the working surface of the at least one controlling board can increase the illumination of the side area of the lighting device and improve the light-homogenizing effect for the light emitted from the lighting device.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a lighting device for a car lamp in accordance with the present invention;

FIG. 2 is a perspective view of a second embodiment of a lighting device for a car lamp in accordance with the present invention;

FIG. 3 is a perspective view of a third embodiment of a lighting device for a car lamp in accordance with the present invention;

FIG. 4 is a side view of the lighting device for a car lamp in FIG. 3; and

FIG. 5 is a perspective view of a fourth embodiment of a lighting device for a car lamp in accordance with the present invention.

### DETAILED DESCRIPTION OF PREFERRED EMBODIMENT

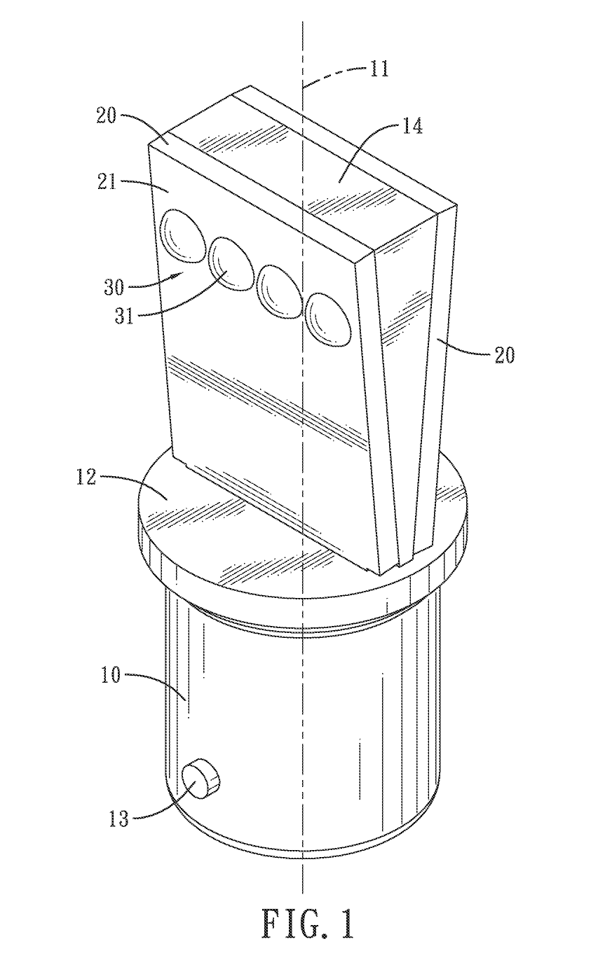

With reference to FIGS. 1 to 4, a lighting device for a car lamp in accordance with the present invention comprises a base 10, at least one controlling board 20 and at least one LED module 30.

The base 10 has an axis 11 and an assembling surface 12. The axis 11 is defined axially through the base 10. The assembling surface 12 is defined radially on the base 10. Furthermore, the base 10 has multiple pins 13 protruding from a side surface of the base 10 to releasably connect with a socket.

The at least one controlling board 20 is mounted on the assembling surface 12 of the base 10 and extends outside the base 10 around the axis 11 of the base 10. Each one of the at least one controlling board 20 has an outer side surface and a working surface 21 formed on the outer side surface. Each working surface 21 is parallel to the axis 11 of the base 10. Alternatively, each working surface 21 is inclined relative to the assembling surface 12 of the base 10.

The at least one LED module 30 is mounted respectively on the working surface 21 of the at least one controlling board 20. Each one of the at least one LED module 30 has at least one LED 31.

With reference to FIG. 1, in a first embodiment of the present invention, the lighting device has a baffle plate 14 and two controlling boards 20. The baffle plate 14 is mounted on and extends outside the assembling surface 12 of the base 10. The controlling boards 20 are mounted respectively at two opposite sides of the baffle plate 14 around the axis 11 of the base 10.

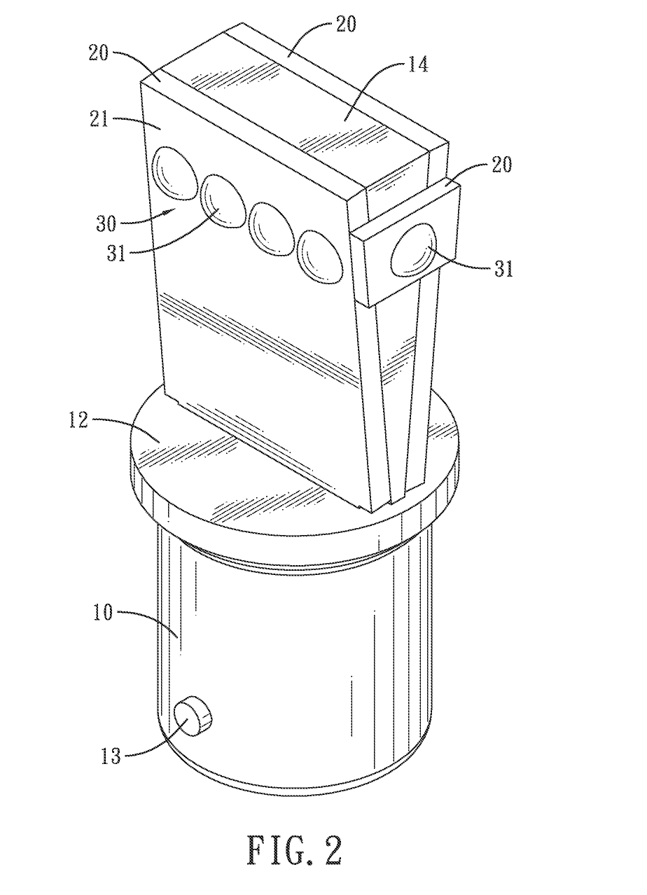

With reference to FIG. 2, in a second embodiment of the present invention, the lighting device has four controlling boards 20 arranged around the baffle plate 14. Furthermore, the baffle plate 14 is a component with a heat dissipation function and may be an aluminum substrate or a heat sink.

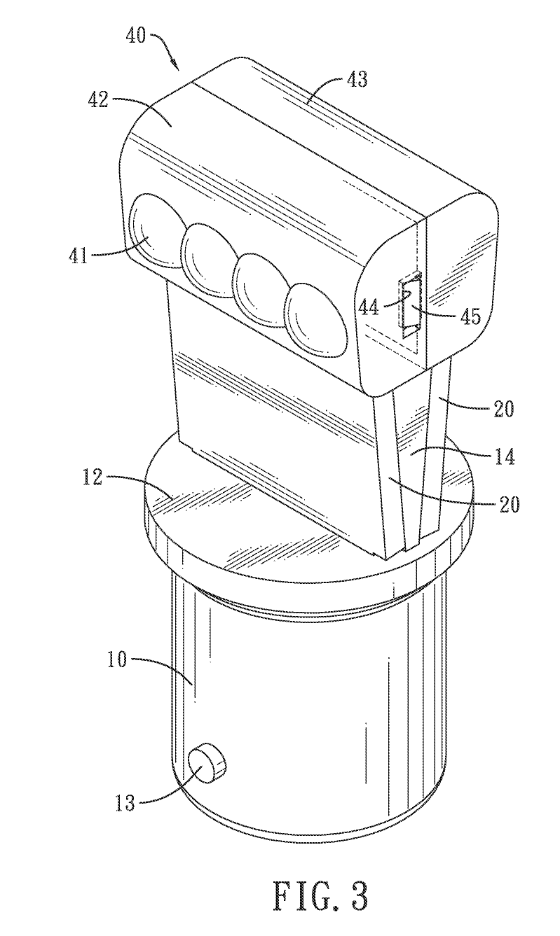

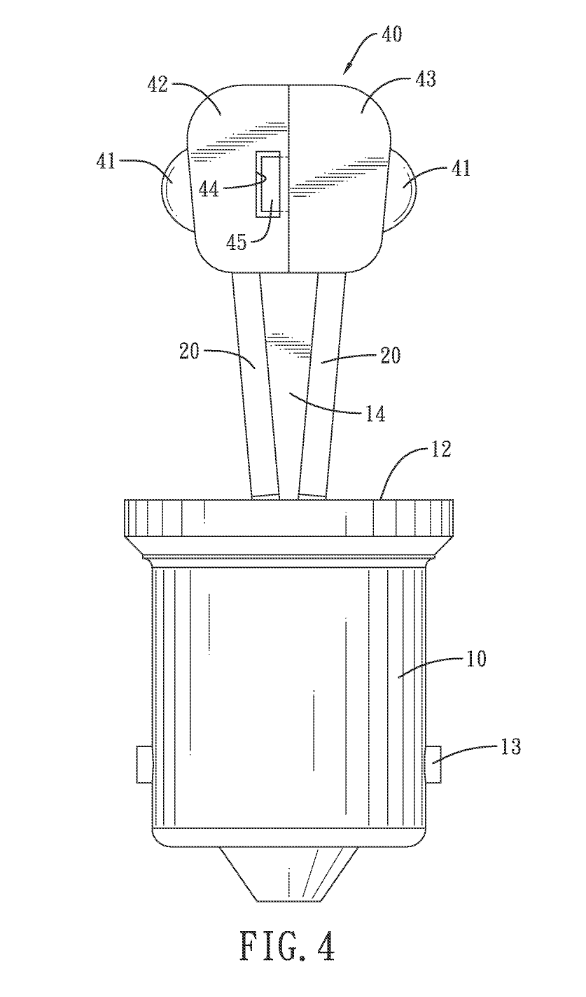

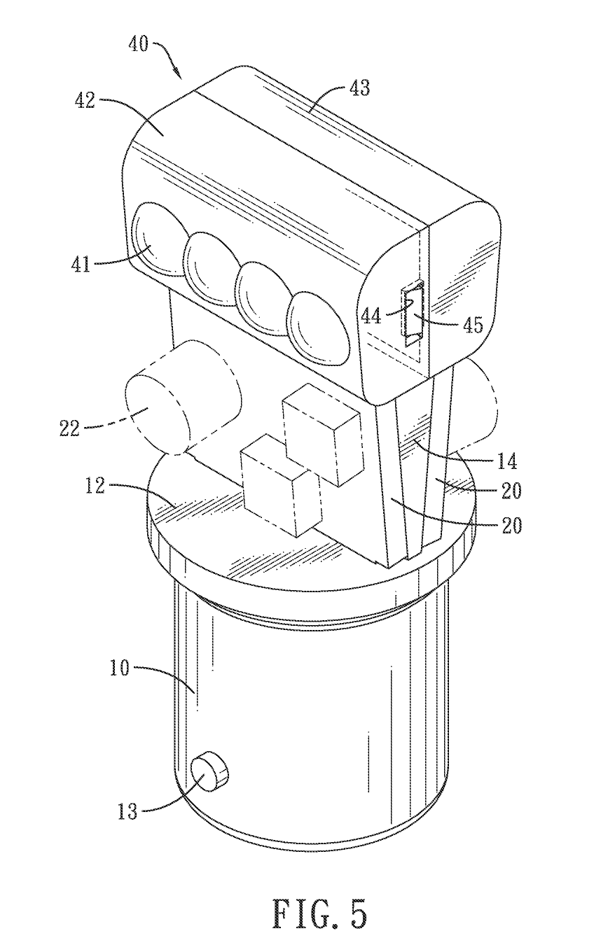

With reference to FIGS. 3 and 4, in a third embodiment of the present invention, the lighting device has a light-homogenizing assembly 40 which is mounted on the at least one controlling board 20 and covers the at least one LED module 30. The light-homogenizing assembly 40 has at least one lens 41 which respectively covers the at least one LED 31 of the at least one LED module 30. Preferably, the light-homogenizing assembly 40 has multiple lenses 41, and the lenses 41 cover the LEDs 31 respectively. The light-homogenizing assembly 40 has a first light-homogenizing cap 42 and a second light-homogenizing cap 43 firmly combined with the first light-homogenizing cap 42. The first light-homogenizing cap 42 has a first engaging hole 44 and a first engaging portion. The second light-homogenizing cap 43 engages the first light-homogenizing cap 42 and has a second engaging hole and a second engaging portion 45. The second engaging hole receives the first engaging portion of the first light-homogenizing cap 42. The second engaging portion 45 is inserted into the first engaging hole 44 of the first light-homogenizing cap 42. With reference to FIG. 5, in a fourth embodiment, the lighting device has at least one electronic element 22 mounted on the working surface 21 of a corresponding one of the at least one controlling board 20.

The lighting device can releasably connect with the socket by the pins 13 of the base 10, and then the lighting device is mounted on a light seat by the socket. A lampshade is mounted on the light seat. A reflector is formed in an inner surface of the light seat. A distal tip of the baffle plate 14 is faced to the lampshade. The light emitted from the at least one LED 31 of the lighting device directly shines on the reflector of the light seat. Alternatively, the light emitted from the at least one LED 31 of the lighting device passes through the lenses 41 and shines on the reflector, and then the light is reflected by the reflector to be emitted out from the lampshade.

Accordingly, the at least one controlling board 20 is mounted on the assembling surface 12 of the base 10 and extends outside the base 10, so the base 10 does not have to provide an extra assembling space for installing the at least one controlling board 20. Thus, the volume of the base 10 is reduced. Moreover, the at least one LED 31 mounted on the working surface 21 of the at least one controlling board 20 can increase the illumination of the side area of the lighting device and improve the light-homogenizing effect for the light emitted from the lighting device.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lighting device for a car lamp comprising:
a base having
an axis defined axially through the base; and
an assembling surface defined radially on the base;
at least one controlling board mounted on the assembling surface of the base and extending outside the base around the axis of the base, and each one of the at least one controlling board having
an outer side surface; and
a working surface formed on the outer side surface; and
at least one LED module mounted respectively on the working surface of the at least one controlling board and each one of the at least one LED module having at least one LED.

2. The lighting device as claimed in claim 1, wherein
the lighting device has
a baffle plate mounted on the assembling surface of the base; and
two controlling boards mounted respectively at two opposite sides of the baffle plate around the axis of the base.

3. The lighting device as claimed in claim 1, wherein
the lighting device has
a baffle plate mounted on the assembling surface of the base; and
four controlling boards arranged around the baffle plate.

4. The lighting device as claimed in claim 1, wherein
the lighting device has
a light-homogenizing assembly mounted on the at least one controlling board and covering the at least one LED module and having
at least one lens respectively covering the at least one LED of the at least one LED module.

5. The lighting device as claimed in claim 2, wherein
the lighting device has
a light-homogenizing assembly mounted on the at least one controlling board and covering the at least one LED module and having
at least one lens respectively covering the at least one LED of the at least one LED module.

6. The lighting device as claimed in claim 3, wherein
the lighting device has
a light-homogenizing assembly mounted on the at least one controlling board and covering the at least one LED module and having
at least one lens respectively covering the at least one LED of the at least one LED module.

7. The lighting device as claimed in claim 4, wherein the light-homogenizing assembly has a first light-homogenizing cap and a second light-homogenizing cap firmly combined with the first light-homogenizing cap.

8. The lighting device as claimed in claim 5, wherein the light-homogenizing assembly has a first light-homogenizing cap and a second light-homogenizing cap firmly combined with the first light-homogenizing cap.

9. The lighting device as claimed in claim 6, wherein the light-homogenizing assembly has a first light-homogenizing cap and a second light-homogenizing cap firmly combined with the first light-homogenizing cap.

10. The lighting device as claimed in claim 7, wherein
the first light-homogenizing cap has a first engaging hole and a first engaging portion; and
the second light-homogenizing cap engages the first light-homogenizing cap and has
a second engaging hole receiving the first engaging portion of the first light-homogenizing cap; and
a second engaging portion inserted into the first engaging hole of the first light-homogenizing cap.

11. The lighting device as claimed in claim 8, wherein
the first light-homogenizing cap has a first engaging hole and a first engaging portion; and
the second light-homogenizing cap engages the first light-homogenizing cap and has
a second engaging hole receiving the first engaging portion of the first light-homogenizing cap; and
a second engaging portion inserted into the first engaging hole of the first light-homogenizing cap.

12. The lighting device as claimed in claim 9, wherein
the first light-homogenizing cap has a first engaging hole and a first engaging portion; and
the second light-homogenizing cap engages the first light-homogenizing cap and has
a second engaging hole receiving the first engaging portion of the first light-homogenizing cap; and
a second engaging portion inserted into the first engaging hole of the first light-homogenizing cap.
